(19) United States
(12) Patent Application Publication
(10) Pub. No.: US 2016/0244585 A1
(43) Pub. Date: Aug. 25, 2016

(54) XEROGELS MADE FROM AROMATIC POLYUREAS

(71) Applicant: BASF SE, Ludwigshafen (DE)

(72) Inventors: VOLKER SCHÄDLER, Ann Arbor, MI (US); Marc FRICKE, Osnabruck (DE); Werner WIEGMANN, Rahden-Wehe (DE); Andreas EMGE, Lemforde (DE); Vijay Immanuel RAMAN, Mannheim (DE); Antonio SANCHEZ-FERRER, Barcelona (ES)

(21) Appl. No.: 15/146,277

(22) Filed: May 4, 2016

Related U.S. Application Data
(63) Continuation of application No. 12/600,350, filed on Nov. 16, 2009.

(30) Foreign Application Priority Data
May 16, 2007 (EP) 07108306.7

(51) Int. Cl. C08J 9/28; E06B 3/677; E06B 3/66

(52) U.S. Cl. CPC C08J 9/28; E06B 3/6612; E06B 3/6775; C08J 2375/02; C08J 2201/0502; C08J 2205/028

(57) ABSTRACT

The invention relates to a xerogel comprising
from 30 to 90% by weight of a monomer component (a1) composed of at least one polyfunctional isocyanate and
from 10 to 70% by weight of a monomer component (a2) composed of at least one polyfunctional aromatic amine, at least one of which is selected from 4,4′-diaminodiphenylmethane, 2,4′-diaminodiphenylmethane, 2,2′-dIamino-diphenylmethane and oligomeric diaminodiphenylmethane,

where the sum of the % by weight of monomer components (a1) and (a2) adds up to 100% by weight and where the monomer components are present in polymeric form in the xerogel and the volume-weighted mean pore diameter of the xerogel is at most 5 μm.

The invention further relates to a process for preparing xerogels, to the xerogels thus obtainable and to the use of the xerogels as an insulating material and in vacuum insulation panels.

The Invention relates to a xerogel comprising
from 30 to 90% by weight of a monomer component (a1) composed of at least one polyfunctional isocyanate and
from 10 to 70% by weight of a monomer component (a2) composed of at least one polyfunctional aromatic amine, at least one of which is selected from 4,4′-diaminodiphenylmethane, 2,4′-diaminodiphenylmethane, 2,2′-diamino-diphenylmethane and oligomeric diaminodiphenylmethane,
   where the sum of the % by weight of monomer components (a1) and (a2) adds up to 100% by weight and where the monomer components are present in polymeric form in the xerogel and the volume-weighted mean pore diameter of the xerogel is at most 5 μm.

The invention further relates to a process for preparing xerogels, to the xerogels thus obtainable and to the use of the xerogels as an insulating material and in vacuum insulation panels.

Porous materials, for example polymer foams, with pores in the size range of significantly below 1 μm and a high porosity of at least 70% are particularly good thermal insulators on the basis of theoretical considerations.

Such porous materials with a small mean pore diameter may be present, for example, in the form of organic xerogels. In the literature, the term “xerogel” is not used uniformly throughout. In general, a xerogel is understood to mean a porous material which has been prepared by a sol-gel process, the liquid phase having been removed from the gel by drying below the critical temperature and below the critical pressure of the liquid phase (“subcritical conditions”). In contrast, reference is generally made to aerogels when the removal of the liquid phase from the gel has been performed under supercritical conditions.

In the sol-gel process, a sol is first prepared on the basis of a reactive organic gel precursor, and then the sol is gelated by a crosslinking reaction to form a gel. In order to obtain a porous material, for example a xerogel, from the gel, the liquid has to be removed. This step is referred to hereinafter in a simplifying manner as drying.

WO-95/02009 discloses isocyanate-based xerogels which are suitable especially for applications in the field of vacuum insulation. The publication additionally discloses a sol-gel-based process for preparing the xerogels using known polyisocyanates including aromatic polyisocyanates and an unreactive solvent. As further compounds with active hydrogen atoms, aliphatic and aromatic polyamines or polyols are used. The examples disclosed in the publication comprise those in which a polyisocyanate is reacted with diaminodiethyltoluene. The xerogels disclosed generally have mean pore sizes in the region of 50 μm. In one example, a mean pore diameter of 10 μm is specified.

The thermal conductivity of the xerogels disclosed is, however, not sufficient for all applications. For applications in the region of pressures above the vacuum range, especially in the pressure range from about 1 to about 100 mbar, the thermal conductivity is generally unsatisfactorily high. In addition, the material properties, especially the mechanical stability of the xerogel and the porosity, are not sufficient for all applications.

It was therefore an object of the invention to provide a porous material which has a low thermal conductivity. Furthermore, the xerogels should have a low thermal conductivity even at pressures above the vacuum range, especially in a pressure range from about 1 mbar to about 100 mbar. This is desirable since a pressure increase occurs in vacuum panels in the course of time. In addition, the porous material should have a high porosity and a sufficiently high mechanical stability. Furthermore, the xerogels should have a low inflammability and a high thermal stability.

A further object consisted in providing a process which makes available a xerogel with low pore size, high porosity and high mechanical stability. In addition, the process for preparing the xerogels should provide porous materials with a low thermal conductivity, especially in the pressure range from 1 to 100 mbar.

Accordingly, the inventive xerogels and a process for preparing xerogels have been found.

Preferred embodiments can be taken from the claims and the description. Combinations of preferred embodiments do not leave the scope of this invention.

### Xerogel

According to the invention, the xerogel comprises from 30 to 90% by weight of a monomer component (a1) composed of at least one polyfunctional isocyanate and from 10 to 70% by weight of a monomer component (a2) composed of at least one polyfunctional aromatic amine, at least one of which is selected from 4,4′-diamino-diphenylmethane, 2,4′-diaminodlphenylmethane, 2,2′-diaminodphenylmethane and oligomeric diaminodiphenylmethane. Monomer components (a1) and (a2) are present in polymeric form in the xerogel. According to the invention, the volume-weighted mean pore diameter of the xerogel is at most 5 μm.

The xerogel preferably comprises from 40 to 80% by weight of monomer component (a1) and from 20 to 70% by weight of monomer component (a2). The xerogel especially preferably comprises from 50 to 70% by weight of monomer component (a1) and from 30 to 50% by weight of monomer component (a2).

In the context of the present invention, a xerogel is understood to mean a porous material having a porosity of at least 70% by volume and a volume-weighted mean pore size of at most 50 micrometers, which has been prepared by a sol-gel method, the liquid phase having been removed from the gel by drying below the critical temperature and below the critical pressure of the liquid phase (“subcritical conditions”).

In the context of the present invention, functionality of a compound shall be understood to mean the number of reactive groups per molecule. In the case of monomer component (a1), the functionality is the number of isocyanate groups per molecule. In the case of the amino groups of monomer component (a2), the functionality is the number of reactive amino groups per molecule. A polyfunctional compound has a functionality of at least 2.

If monomer components (a1) or (a2) used are mixtures of compounds with different functionality, the functionality of the components is calculated from the number-weighted mean of the functionality of the individual compounds. A polyfunctional compound comprises at least two of the abovementioned functional groups per molecule.

The mean pore diameter is determined by means of mercury intrusion measurement to DIN 66133 and is always a volume-weighted mean value in the context of the present invention. The mercury intrusion measurement to DIN 66133 is a porosimetry method and is performed in a porosimeter. In this method, mercury is pressed into a sample of the porous material. Small pores require a higher pressure to be filled with the mercury than large pores, and the corresponding pressure/volume diagram can be used to determine a pore size distribution and the volume-weighted mean pore diameter.

According to the invention, the volume-weighted mean pore diameter of the xerogel is at most 5 μm. The volume-weighted mean pore diameter of the xerogel is preferably at most 3.5 μm, more preferably at most 3 μm and especially at most 2.5 μm.

A minimum pore size with high porosity is desirable from the point of view of low thermal conductivity. However, for production reasons and in order to obtain a sufficiently mechanically stable xerogel, a practical lower limit in the volume-weighted mean pore diameter arises. In general, the volume-weighted mean pore diameter is at least 200 nm, preferably at least 400 nm. In many cases, the volume-weighted mean pore diameter is at least 500 nm, especially at least 1 micrometer.

The inventive xerogel preferably has a porosity of at least 70% by volume, especially from 70 to 99% by volume, more preferably at least 80% by volume, most preferably at least 85% by volume, especially from 85 to 95% by volume. The porosity in % by volume means that the reported proportion of the total volume of the xerogel consists of pores. Although a maximum porosity is usually desirable from the point of view of minimal thermal conductivity, the upper limit in the porosity arises through the mechanical properties and the processability of the xerogel.

According to the invention, monomer components (a1) and (a2), referred to hereinafter as components (a1) and (a2), are present in polymeric form in the xerogel. Owing to the inventive composition, components (a1) and (a2) are present in the xerogel bonded predominantly via urea linkages. A further possible linkage in the xerogel is that of isocyanurate linkages, which arise through trimerization of isocyanate groups of component (a1), When the xerogel comprises further monomer components, further possible linkages are, for example, urethane groups which are formed by reaction of isocyanate groups with alcohols or phenols.

Components (a1) and (a2) are preferably present in the xerogel linked by urea groups —NH—CO—NH— to an extent of at least 50 mol %. Components (a1) and (a2) are preferably present in the xerogel from 50 to 100 mol % linked by urea groups, especially from 60 to 100 mol %, even more preferably from 70 to 100 mol %, especially from 80 to 100 mol %, for example from 90 to 100 mol %.

The molar % lacking from 100 mol % are present in the form of further linkages, especially as isocyanurate linkages. The further linkages may, however, also be present in the form of other linkages of isocyanate polymers known to those skilled in the art. Examples include ester, urea, bluret, allophanate, carbodiimide, isocyanurate, uretdione and/or urethane groups.

The molar % of the linkages of the monomer components in the xerogel are determined by means of NMR spectroscopy (nuclear spin resonance) in the solid or in the swollen state. Suitable determination methods are known to those skilled in the art.

The use ratio (equivalence ratio) of NCO groups of monomer components (a1) to amino groups of monomer component (a2) is preferably from 0.9:1 to 1.3:1. The equivalence ratio of NCO groups of monomer component (a1) to amino groups of monomer component (a2) is more preferably from 0.95:1 to 1.2:1, especially from 1:1 to 1.1:1.

According to the invention, the xerogel comprises from 40 to 80% by weight of at least one polyfunctional isocyanate in polymeric form. Useful polyfunctional isocyanates include aromatic, aliphatic, cycloallphatic and/or araliphatic isocyanates. Such polyfunctional isocyanates are known per se or can be prepared by methods known per se. The polyfunctional isocyanates can especially also be used in the form of mixtures, such that component (a1) in this case comprises different polyfunctional isocyanates. Polyfunctional isocyanates useful as a constituent of component (a1) have two (referred to hereinafter as diisocyanates) or more than two isocyanate groups per molecule of the monomer component.

Especially suitable are diphenylmethane 2,2′-, 2,4′- and/or 4,4′-dilsocyanate (MDI), naphthylene 1,5-diisocyanate (NDI), tolylene 2,4- and/or 2,6-dilsocyanate (TDI), dimethyldiphenyl 3,3′-diisocyanate, diphenylethane 1,2-dilsocyanate and/or p-phenylene diisocyanate (PPDI), tri-, tetra-, penta-, hexa-, hepta- and/or octamethylene diisocyanate, 2-methylpentamethylene 1,5-dilsocyanate, 2-ethylbutylene 1,4-dilsocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethylcyclohexane (HXDI), 1,4-cyclohexane diisocyanate, 1-methylcyclohexane 2,4- and/or 2,6-diisocyanate and/or dicyclohexylmethane 4,4′-, 2,4′- and 2,2′-diisocyanate.

Preferred polyfunctional isocyanates of component (a1) are aromatic isocyanates. Particularly preferred polyfunctional isocyanates of component (a1) have the following embodiments:

I) polyfunctional isocyanates based on tolylene diisocyanate (TDI), especially 2,4-TDI or 2,6-TDI or mixtures of 2,4- and 2,6-TDI;

ii) polyfunctional isocyanates based on diphenylmethane diisocyanate (MDI), especially 2,2′-MDI or 2,4′-MDI or 4,4′-MDI or oligomeric MDI, which is also referred to as polyphenylpolymethylene isocyanate, or mixtures of two or three of the aforementioned diphenylmethane diisocyanates, or crude MDI which is obtained in the preparation of MDI, or mixtures of at least one oligomer of MDI and at least one of the aforementioned low molecular weight MDI derivatives;

iii) mixtures of at least one aromatic isocyanate according to embodiment i) and at least one aromatic isocyanate according to embodiment ii).

As a polyfunctional isocyanate, particular preference is given to oligomeric diphenylmethane diisocyanate. Oligomeric diphenylmethane dilsocyanate (referred to hereinafter as oligomeric MDI) is one oligomeric condensation product or a mixture of a plurality of oligomeric condensation products and hence derivatives of diphenylmethane diisocyanate (MDI). The polyfunctional isocyanates may preferably also be formed from mixtures of monomeric aromatic diisocyanates and oligomeric MDI.

Oligomeric MDI comprises one or more polycyclic condensation products of MDI having a functionality of more than 2, especially 3 or 4 or 5. Oligomeric MDI is known and is frequently referred to as polyphenylpolymethylene isocyanate. Oligomeric MDI is typically formed from a mixture of MDI-based isocyanates with different functionality. Typically, oligomeric MDI is used in a mixture with monomeric MDI.

The (mean) functionality of an isocyanate which comprises oligomeric MDI may vary in the range from about 2.3 to about 5, especially from 2.5 to 3.5, especially from 2.5 to 3. Such a mixture of MDI-based polyfunctional isocyanates with different functionalities is especially crude MDI, which is obtained in the preparation of MDI.

Polyfunctional isocyanates or mixtures of a plurality of polyfunctional isocyanates based on MDI are known and are sold, for example, by Elastogran GmbH under the name Lupranat®.

The functionality of component (a1) is preferably at least two, especially at least 2.2 and more preferably at least 2.5. The functionality of component (a1) is preferably from 2.6 to 4 and more preferably from 2.5 to 3.

The content of isocyanate groups in component (a1) is preferably from 5 to 10 mmol/g, especially from 6 to 9 mmol/g, more preferably from 7 to 8.5 mmol/g. It is known to those skilled in the art that the content of isocyanate groups in mmol/g and the so-called equivalence weight in g/equivalent are in a reciprocal ratio. The content of isocyanate groups in mmol/g is calculated from the content in % by weight to ASTM D-5155-96 A.

In a particularly preferred embodiment, monomer component (a1) consists of at least one polyfunctional isocyanate selected from diphenylmethane 4,4′-diisocyanate, diphenylmethane 2,4′-dilsocyanate, diphenylmethane 2,2′-diisocyanate and oligomeric diphenylmethane dilsocyanate.

In this particularly preferred embodiment, component (a1) most preferably comprises oligomeric diphenylmethane diisocyanate and has a functionality of at least 2.5.

According to the invention, the monomer component (a2) consists of at least one polyfunctional aromatic amine, at least one of which is selected from 4,4′-diamino-diphenylmethane, 2,4′-diaminodiphenylmethane, 2,2′-diaminodiphenylmethane and oligomeric diaminodiphenylmethane.

When the monomer component (a2) used is 4,4′-diaminodiphenylmethane, 2,4′-diaminodiphenylmethane, 2,2-diaminodiphenylmethane and/or oligomeric diaminodiphenylmethane in a mixture with a further polyfunctional aromatic amine, useful further polyfunctional aromatic amines are preferably toluenediamine, especially toluene-2,4-diamine and/or toluene-2,6-diamine and diethyltoluenediamine, especially 3,5-diethyltoluene-2,4-diamine and/or 3,5-diethyltoluene-2,6-diamine.

Preferably, monomer component (a2) consists of at least one polyfunctional aromatic amine selected from 4,4′-diaminodiphenylmethane, 2,4′-diaminodiphenylmethane, 2,2′-diaminodiphenylmethane and oligomeric diaminodiphenylmethane.

Oligomeric diaminodiphenylmethane comprises one or more polycyclic methylene-bridged condensation products of aniline and formaldehyde. Oligomeric MDA comprises at least one oligomer of MDA, but generally a plurality of ollgomers of MDA, having a functionality of more than 2, especially 3 or 4 or 5.Oligomeric MDA is known or can be prepared by methods known per se. Typically, oligomeric MDA is used in the form of mixtures with monomeric MDA.

The (mean) functionality of a polyfunctional amine which comprises oligomeric MDA can vary in the range from about 2.3 to about 5, especially from 2.5 to 3.5 and especially from 2.5 to 3. Such a mixture of MDA-based polyfunctional amines with different functionalities is especially crude MDA which is formed especially in the condensation of aniline with formaldehyde, typically catalyzed by hydrochloric acid, as an intermediate of the preparation of crude MDI. Monomer component (a2) preferably comprises oligomeric diaminodiphenylmethane and has a functionality of at least 2.5.

Process for Preparing Xerogels

The process according to the invention comprises the following steps:

(a) providing a gel precursor (A) comprising monomer components (a1) and (a2) in a solvent (C);

(b) converting the gel precursor (A) in the presence of the solvent (C) to a gel;

(d) drying the gel obtained in the previous step by converting the liquid present in the gel to the gaseous state at a temperature and a pressure below the critical temperature and the critical pressure of the liquid present in the gel.

In a preferred embodiment, monomer components (a1) and (a2) are first provided separately in one solvent (C) each and finally combined at the start of step (b). The process according to the invention accordingly preferably comprises the following steps:

(a-1) providing monomer components (a1) and (a2) separately in one solvent (C) each;

(a-2) providing a gel precursor (A) comprising monomer components (a1) and (a2) in a solvent (C) by combining the monomer components provided in step (a-1);

(b) converting the gel precursor (A) in the presence of the solvent (C) to a gel;

(d) drying the gel obtained in the previous step by converting the liquid present in the gel to the gaseous state at a temperature and a pressure below the critical temperature and the critical pressure of the liquid present in the gel.

The process according to the invention preferably further comprises the following step, the steps being performed in the sequence a-b-c-d:

(c) modifying the resulting gel by means of at least one organic compound (D) which was present neither in step (a) nor in step (b).

### Step (a)

According to the invention, in step (a), a gel precursor (A) comprising monomer components (a1) and (a2) is prepared in a solvent (C). The gel precursor (A) thus comprises the monomer components (a1) and (a2) described above under xerogel in the proportions likewise described above.

Monomer components (a1) and (a2) are present in the gel precursor (A) in monomeric form or have been converted beforehand by partial or nonequimolar reaction of isocyanate and amino groups to a prepolymer which forms the gel precursor (A). If appropriate with further monomer components (a1) or (a2). The gel precursor (A) is thus gelable, i.e. it can be converted to a gel by crosslinking. The proportions of monomer components (a1) and (a2) in the xerogel, in which they are present in polymeric form, correspond to the proportions of monomer components (a1) and (a2) in the gel precursor (A) in which they are present in as yet unconverted monomeric form.

The viscosity of component (a1) used may vary within a wide range. Component (a1) used in step (a) of the process according to the invention preferably has a viscosity from 100 to 3000 mPa.s, more preferably from 200 to 2500 mPa.s.

The term “gel precursor (A)” indicates the gelable mixture of components (a1) and (a2). The gel precursor (A) is subsequently converted in step (b), in the presence of the solvent (C), to a gel, a crosslinked polymer.

In step (a) of the process according to the invention, a mixture comprising the gel precursor (A) in a liquid diluent is thus provided. In the context of the present invention, the term “solvent (C)” comprises liquid diluents, i.e. both solvents in the narrower sense and dispersants. The mixture may especially be a true solution, a colloidal solution or a dispersion, for example an emulsion or suspension. The mixture is preferably a true solution. The solvent (C) is a compound which is liquid under the conditions of step (a), preferably an organic solvent.

It is known to those skilled in the art that aromatic amines, especially diamines, are formed when aromatic isocyanates, especially diisocyanates, are reacted with water. Accordingly, it is possible, instead of polyfunctional aromatic amines, to use corresponding aromatic polyfunctional isocyanates and an equivalent amount of water as component (a2), such that the desired amount of polyfunctional aromatic amine is formed in situ or in a preliminary reaction. In the case of an excess of component (a1) and simultaneous addition of water, component (a1) can be converted in situ partly to component (a2), which then reacts immediately with the remaining component (a1) to form urea linkages.

However, the polyfunctional amine is preferably not obtained from component (a2) in the presence of monomer component (a1) in the solvent (C), but rather is added separately as component (a2). Accordingly, the mixture provided in step (a) preferably does not comprise any water.

Useful solvents (C) include in principle one compound or a mixture of a plurality of compounds, the solvent (C) being liquid under the pressure and temperature conditions under which the mixture is provided in step (a) (dissolution conditions for short). The composition of the solvent (C) is selected such that it is capable of dissolving or dispersing the organic gel precursor, preferably of dissolving it. Preferred solvents (C) are those which are a solvent for the organic gel precursor (A). I.e. those which dissolve the organic gel precursor (A) completely under reaction conditions.

The reaction product from step (b) is a gel, (.e. a viscoelastic chemical network which is swollen by the solvent (C), A solvent (C) which is a good swelling agent for the network formed in step (b) generally leads to a network with fine pores and small mean pore diameter, whereas a solvent (C) which is a poor swelling agent for the gel resulting from step (b) leads generally to a coarse-pore network with large mean pore diameter.

The selection of the solvent (C) thus influences the desired pore size distribution and the desired porosity. The solvent (C) is generally additionally selected such that precipitation or flocculation as a result of formation of a precipitated reaction product very substantially does not occur during or after step (b) of the process according to the invention.

In the case of selection of a suitable solvent (C), the proportion of precipitated reaction product is typically less than 1% by weight based on the total weight of the mixture. The amount of precipitated product formed in a particular solvent (C) can be determined gravimetrically by filtering the reaction mixture through a suitable filter before the gel point.

Useful solvents (C) include the solvents known from the prior art for isocyanate-based polymers. Preferred solvents are those which are a solvent for both components, (a1) and (a2), i.e. those which dissolve components (a1) and (a2) substantially completely under reaction conditions, such that the content of the organic gel precursor (A) in the overall mixture provided in step (a) including the solvent (C) is preferably at least 5% by weight. The solvent (C) is preferably inert, i.e. unreactive, toward component (a1).

Useful solvents (C) include, for example, dialkyl ethers, cyclic ethers, ketones, alkyl alkanoates, amides such as formamide and N-methylpyrrolidone, sulfoxides such as dimethyl sulfoxide, aliphatic and cycloaliphatic halogenated hydrocarbons, halogenated aromatic compounds and fluorinated ethers. Likewise useful are mixtures of two or more of the aforementioned compounds.

Additionally useful as solvents (C) are acetals, especially diethoxymethane, dimethoxymethane and 1,3-dioxolane.

Dialkyl ethers and cyclic ethers are preferred as solvents (C). Preferred dialkyl ethers are especially those having from 2 to 6 carbon atoms, especially methyl ethyl ether, diethyl ether, methyl propyl ether, methyl isopropyl ether, propyl ethyl ether, ethyl isopropyl ether, dipropyl ether, propyl isopropyl ether, dilsopropyl ether, methyl butyl ether, methyl isobutyl ether, methyl t-butyl ether, ethyl n-butyl ether, ethyl isobutyl ether and ethyl t-butyl ether. Preferred cyclic ethers are especially tetrahydrofuran, dioxane and tetrahydropyran.

Ketones having alkyl groups having up to 3 carbon atoms per substituent are likewise preferred as solvents (C). Particularly preferred solvents (C) are the following ketones: acetone, cyclohexanone, methyl t-butyl ketone and methyl ethyl ketone.

Also preferred as solvents (C) are alkyl alkanoates, especially methyl formate, methyl acetate, ethyl formate, butyl acetate and ethyl acetate. Preferred halogenated solvents are described in WO 00/24799, page 4'line 12 to page 5 line 4.

Dialkyl ethers, cyclic ethers, ketones and esters are very particularly preferred as solvents (C).

In many cases, particularly suitable solvents (C) arise by using two or more compounds which are completely miscible with one another and are selected from the aforementioned solvents in the form of a mixture.

In order to obtain, in step (b), a sufficiently stable gel which does not shrink greatly in the course of drying in step (d), the proportion of the gel precursor (A) in the overall mixture provided in step (a) of the process according to the invention generally must not be less than 5% by weight. The proportion of the gel precursor (A) in the overall mixture provided in step (a) of the process according to the invention including the solvent (C) is preferably at least 8% by weight, more preferably at least 10% by weight, especially at least 12% by weight.

On the other hand, the concentration of the monomer components in the mixture provided must not be selected at too high a level, since a xerogel with favorable properties is otherwise not obtained. In general, the proportion of the gel precursor (A) in the overall mixture provided in step (a) of the process according to the invention is at most 40% by weight. The proportion of the gel precursor (A) in the overall mixture provided in step (a) of the process according to the Invention including the solvent (C) is preferably at most 30% by weight, more preferably at most 20% by weight, especially at most 15% by weight.

Optionally, the mixture provided in step (a) comprises, as a further component (B), also at least one catalyst (131). However, preference is given to performing the conversion of the gel precursor (A) without the presence of a catalyst.

When a catalyst (b1) is used, typically trimerization catalysts which catalyze the formation of isocyanurates are used. Such trimerization catalysts used may, for example, be catalysts widely known to those skilled in the art, for example those listed below.

When trimerization catalysts are used as component (b1), known catalysts such as quaternary ammonium hydroxides, alkali metal and alkaline earth metal hydroxides, alkali metal and alkaline earth metal alkoxides, and alkali metal and alkaline earth metal carboxylates, e.g. potassium acetate and potassium 2-ethylhexanoate, particular tertiary amines and nonbasic metal carboxylates, e.g. lead octoate and triazine derivatives, especially symmetrical triazine derivatives, are suitable. Triazine derivatives are particularly suitable as trimerization catalysts.

Components (a1) and (a2) are preferably used such that the gel precursor (A) comprises from 30 to 90% by weight of component (a1) and from 10 to 70% by weight of component (a2). The gel precursor (A) preferably comprises from 40 to 80% by weight of component (a1) and from 20 to 60% by weight of component (a2). The gel precursor especially preferably comprises from 50 to 70% by weight of component (a1) and from 30 to 50% by weight of component (a2).

The use ratio (equivalence ratio) of components (a1) and (a2) of the organic gel precursor (A) is, in a preferred embodiment, selected such that, on completion of gelation in step (b), the gel still has reactive groups which can be converted in step (c) by chemical reaction with an organic compound (D) which was present neither in step (a) nor in step (b). For example, the organic gel precursor (A) may comprise reactive groups which do not react until they do so with compound (D), in a particularly preferred embodiment, the organic compound (D) reacts with reactive groups which were already present in the organic gel precursor (A) and did not react completely in the course of the conversion to a gel in step (b). A reactive group shall be understood to mean a functional group or a reactive site in a molecule, for example a position in an aromatic ring, which is reactive toward the compound (D).

In one embodiment, the organic gel precursor (A) comprises components (a1) and (a2) in a nonstoichiometric ratio of the reactive functional groups, such that, at the start of step (c) of the process according to the invention, the reactive functional groups of one of the two components (a1) or (a2) are present in a molar excess relative to the reactive functional groups of the other component in each case in unconverted form.

The molar excess of reactive functional groups of one of the two components (a1) or (a2) at the start of step (c) of the process according to the invention relative to the reactive functional groups of the other component in each case is preferably at least 5 mol %, for example from 6 to 15 mol %, especially from 6 to 12 mol %. The upper limit in the excess of the reactive groups in one component in each case arises through practical considerations, since a gel must form in step (b) of the process according to the invention.

In a particularly preferred embodiment, component (a1) is used in relation to component (a2) such that the excess of isocyanate groups at the start of step (c) of the process according to the invention is at least 5 mol %, especially from 5 to 16 mol %, most preferably from 6 to 12 mol %.

In a further preferred embodiment, component (a1) is used in relation to component (a2) such that the excess of groups in component (a2) reactive toward isocyanate groups, at the start of step (c) of the process according to the invention, is at least 5 mol %, especially from 5 to 15 mol %, most preferably from 6 to 12 mol %.

The mixture provided in step (a) may also comprise typical assistants known to those skilled in the art as further constituents (B). Examples include surface-active substances, flame retardants, nucleating agents, oxidation stabilizers, lubricating and demolding aids, dyes and pigments, stabilizers, for example against hydrolysis, light, heat or discoloration, inorganic and/or organic fillers, reinforcing agents and biocides.

Further details of the assistants and additives mentioned above can be taken from the technical literature, for example from Plastics Additive Handbook, 5th edition, H. Zweifel, ed, Hanser Publishers, Munich, 2001.

The mixture can be provided in step (a) of the process according to the invention in a typical manner. For this purpose, a stirrer or another mixing apparatus is preferably used to achieve good mixing, The other mixing conditions are generally uncritical; for example, it is possible to mix at from 0 to 100° C. and from 0.1 to 10 bar (absolute), especially, for example, at room temperature and atmospheric pressure.

The mixture provided in step (a) can also be referred to as a sol. A sol shall be understood to mean either a colloidal solution in which the organic gel precursor (A) is dispersed ultrafinely in a solvent as a dispersion medium, or a true solution of the organic gel precursor (A) in a solvent.

### Step (b)

According to the invention, in step (b), the gel precursor (A) is converted to a gel in the presence of the solvent (C). In step (b) of the process according to the invention, the organic gel precursor (A) is thus converted to a gel in a gelation reaction. The gelation reaction is a polyaddition reaction, especially a polyaddition of isocyanate groups and amino groups.

A gel shall be understood to mean a crosslinked system based on a polymer which is present in contact with a liquid (so-called solvogel or lyogel, or with water as a liquid: aquagel or hydrogel). In this case, the polymer phase forms a continuous three-dimensional network.

In step (b) of the process according to the invention, the gel forms typically by being left to stand, for example by simply leaving the vessel, reaction vessel or reactor in which the mixture is present to stand (referred to hereinafter as gelation apparatus). During the gelation (gel formation), the mixture is preferably not stirred or mixed because this might hinder the formation of the gel. It has been found to be advantageous to cover the mixture during the gelation or to close the gelation apparatus.

The duration of the gelation varies according to the type and amount of components used and the temperature and may be several days. It is typically from 1 minute to 10 days, preferably less than 1 day, especially from 5 minutes to 12 hours, more preferably at most 1 hour, especially from 5 minutes to 1 hour.

The gelation can be performed without supplying heat at a temperature in the region of room temperature, especially from 15 to 25° C., or at a temperature elevated relative to room temperature which is 20° C. or more, especially from 25° C. to 80° C. Typically, a higher gelation temperature shortens the duration of gelation. However, a higher gelation temperature is not advantageous in all cases, since an elevated gelation temperature can lead to gels with inadequate mechanical properties. Preference is given to performing the gelation at a temperature in the region of room temperature, especially from 15° C. to 25° C.

The pressure in the course of gelation can vary within a wide range and is generally not critical. It may, for example, be from 0.1 bar to 10 bar, preferably from 0.5 bar to 8 bar and especially from 0.9 to 5 bar (in each case absolute). In particular, it is possible to allow aqueous mixtures to gel at room temperature and atmospheric pressure.

During the gelation, the mixture solidifies to a more or less dimensionally stable gel. Gel formation can therefore be recognized in a simple manner by the contents of the gelation apparatus no longer moving when the gelation apparatus or a vessel with which a sample has been taken is tilted slowly. Moreover, the acoustic properties of the mixture change in the course of gelation: when the outer wall of the gelation apparatus is tapped, the gelled mixture gives a different ringing sound from the as yet ungelled mixture (so-called ringing gel).

In a preferred embodiment, the gel obtained in the gelation in step (b), before step (c) is performed or, when step (c) is not performed, before step (d), is subjected to a so-called aging in which the formation of the gel is completed. The aging is effected especially by exposing the gel to a higher temperature than in the preceding gelation for a certain time. To this end, for example, a heating bath or a heating cabinet can be used, or the apparatus or environment in which the gel is present can be heated in a suitable manner.

The temperature in the course of aging can vary within a wide range and is not critical per se. In general, aging is effected at temperatures of from 30° C. to 150° C., preferably from 40° C. to 100° C., The aging temperature should be in the range from 10° C. to 100° C., especially from 20° C. to 80° C., above the gelation temperature. When gelation has been effected at room temperature, it is possible to effect aging especially at temperatures of from 40° C. to 80° C., preferably at about 60° C. The pressure in the course of aging is uncritical and is typically from 0.9 to 5 bar (absolute).

The duration of the aging depends on the type of the gel and may be a few minutes, but may also take a long time. The duration of the aging may, for example, be up to 30 days. Typically, the duration of the aging is from 10 minutes to 12 hours, preferably from 20 minutes to 6 hours and more preferably from 30 minutes to 5 hours.

According to the type and composition, the gel may shrink slightly during the aging and become detached from the wall of the gelation apparatus. Advantageously, the gel is covered during the aging, or the gelation apparatus in which the gel is present is closed.

### Step (c)

In an optional preferred embodiment, in step (c) of the process according to the invention, the gel obtained in step (b) is modified by means of at least one organic compound (D) which was present neither in step (a) nor in step (b).

The organic compound (D) may either be formed exclusively from nonmetals or comprise semimetals or metals. The organic compounds (D), however, preferably do not comprise any metals or any semimetals such as silicon. The organic compound (D) preferably comprises reactive functional groups which are reactive toward the gel obtained in step (b).

The modification preferably reduces the compatibility of the resulting gel, especially the compatibility of the pore surface of the gel, with the solvent (C). The compound (D) is thus preferably a compound which comes into contact with the pore surface of the gel from step (b) and remains there, which reduces the compatibility of the resulting gel with the solvent (C). Reduction of the compatibility is understood to mean that the attractive interaction between the gel and the liquid phase in contact with the gel is reduced. In the context of the present Invention, the compatibility is thus a thermodynamic compatibility, decreasing compatibility being accompanied by increasing microscopic separation, i.e. the components have, in the case of a reduced compatibility, a reduced tendency to penetrate at the molecular level, especially in the form of swelling of the gel by the solvent (C). Compatibility of gel and solvent (C) is understood to mean the strength of the physicochemical interaction between the pore surface of the gel and the solvent. It is determined by physicochemical interactions, for example the interaction between apolar compounds or dipole-dipole interactions or hydrogen bonds.

Preferred compounds (D) in the process according to the invention are in principle those organic compounds which are unreactive toward the solvent (C). Unreactive toward the solvent (C) means that the compound (D) does not enter into a chemical reaction with the solvent and is especially not hydrolyzed and not solvolyzed by the solvent (C).

Modification of the gel shall be understood to mean any measure in which the pore surface of the gel is modified by at least one compound (D). Preference is given to effecting the modification by a chemical reaction between the compound (D) and the gel (referred to hereinafter as chemical modification), especially in the region of the pore surface of the gel. In principle, the modification can also be effected by physicochemical interactions which do not arise through a chemical reaction in the actual sense, especially through hydrogen bonds or other intermolecular interactions, for example ionic interactions and donor-acceptor interactions, such that no chemical modification is present here. The physicochemical interactions must at least be sufficiently great that the compatibility of the gal thus modified with the solvent is altered. However, preference is given to chemically modifying the resulting gel in step (c).

A pore surface is considered to be that region of the gel which is accessible by the compound (D), i.e. is either on the interface between gel and liquid or can be reached by the liquid present in the pores of the gel, especially as a result of swelling.

In this preferred embodiment, the compatibility is preferably determined by contacting the gel with the solvent (C) until the time at which the end point of the swelling is attained and determining the swelling capacity. The reduction in the swelling capacity serves to characterize the reduction in the compatibility of the gel with the solvent (C). The inventive modification of the resulting gel by means of at least one organic compound (D) in step (c) of the process according to the invention preferably reduces the swelling capacity of the gel in the solvent (C). Reduction in the swelling capacity (SC) is understood to mean SC=(Vₚₛ-V₀)/V₀ where Vₚₛ is the partial specific volume of the polymer in the gel under swollen conditions and V₀ is the specific volume in the unswollen dry state, The specific volumes can be determined, for example, by pycnometry to DIN 66137.

As a result of the reduced compatibility, the phase separation of polymer and solvent is enhanced. This results generally in an increased pore volume and an elevated porosity after the drying of the modified gel compared to the unmodified gel.

The swelling capacity can be used to compare the compatibility between gels obtainable under otherwise identical conditions in order thus to determine the influence of the modification of the gel in step (c) of the process according to the invention. The gel is modified preferably by reaction with chemical groups in the region of the pore surface of the gel (chemical modification), in the case of a chemical modification of the gel, crosslinking can simultaneously be effected in the region of the pore surface if a compound (D) including more than one reactive functional group is used.

When the resulting gel still comprises reactive isocyanate groups, useful compounds (D) are preferably amines which are reactive toward isocyanates and whose reaction with the gel results in reduced compatibility of the resulting gel with the solvent. In this case, useful compounds (D) are preferably amines which have a polarity opposite to that of the solvent and are reactive toward isocyanates.

Opposite polarity shall be understood to mean an opposite direction of the polarity and not an absolute magnitude. The modification with at least one compound (D) having opposite polarity in step (c) of the process according to the Invention lowers the compatibility with the solvent. In the case of a polar solvent (C), “opposite” means an isocyanate which lowers the polarity of the pore surface, and, in the case of a (less preferred) nonpolar solvent (C), an isocyanate which increases the polarity of the pore surface. In the case of a moderately polar solvent, there are two possibilities for opposite polarity, an isocyanate which modifies the pore surface in a polar manner or—which is preferred—an isocyanate which lowers the polarity of the pore surface by modification to such an extent that the compatibility with the moderately polar solvent is reduced.

In this preferred embodiment, the amines react with excess isocyanate groups of the gel at the pore surface to form urea groups. This preferably reduces the compatibility of the gel with the solvent (C) used.

Preferred aromatic amines used as compound (D) are especially diphenyl sulfones having at least two amino groups, especially diaminodiphenyl sulfones (DADPS), as the organic compound (D), very particular preference being given to 4,4′-DADPS.

When the resulting gel still comprises reactive amino groups or other groups reactive toward isocyanates, useful compounds (D) are especially compounds which are reactive toward component (a2) and whose reaction with the gel results in a reduced compatibility of the resulting gel with the solvent (C). In particular, the compounds (D) reactive toward component (a2) may have a polarity opposite to that of the solvent.

In particular, useful compounds (D) in this second preferred embodiment include the polyfunctional isocyanates (a1) discussed above, in which case, in accordance with the invention, the compound (D) was not part of the organic gel precursor (A) in steps (a) and (b) of the process according to the invention and, additionally preferably, the polarity of the pore surface is modified in the opposite direction.

### Step (d)

According to the invention, in step (d), the gel obtained in the previous step is dried by converting the liquid present in the gel to the gaseous state at a temperature and a pressure below the critical temperature and the critical pressure of the liquid present in the gel.

Preference is given to drying the resulting gel by converting the solvent (C) to the gaseous state at a temperature and a pressure below the critical temperature and the critical pressure of the solvent (C). Accordingly, preference is given to effecting the drying by removing the solvent (C) which was present in the reaction without preceding exchange for a further solvent.

Consequently, after step (c) or step (b) and before step (d), the gel is preferably not contacted with an organic liquid in order to exchange the solvent (C) present in the gel, especially in the pores of the gel, for this organic liquid. This is true irrespective of whether the gel is aged or not, When a solvent exchange is omitted, the process can be performed in a particularly simple and inexpensive manner. When, however, a solvent exchange is performed, it is preferred to exchange the solvent (C) for a nonpolar solvent, especially for hydrocarbons such as pentane.

For the drying by conversion of the liquid present in the gel, preferably the solvent (C), to the gaseous state, useful methods are in principle both vaporization and evaporation, but not sublimation. Drying by vaporization or evaporation includes especially drying under atmospheric pressure, drying under reduced pressure, drying at room temperature and drying at elevated temperature, but not freeze-drying.

According to the invention, drying is effected at a pressure and a temperature which are below the critical pressure and below the critical temperature of the liquid present in the gel. In step (d) of the process according to the invention, the solvent-containing gel is thus dried to form the organic xerogel as the process product.

To dry the gel, the gelation apparatus is typically opened and the gel is kept under the stated pressure and temperature conditions until the liquid phase has been removed by conversion to the gaseous state, i.e. the liquid phase is vaporized or evaporated. In order to accelerate the vaporization, it is frequently advantageous to remove the gel from the vessel. In this way, the gel/ambient air phase interface over which the vaporization and/or evaporation takes place is enlarged. For example, the gel can be placed onto a flat underlay or a sieve for drying. Useful drying processes are also the drying processes familiar to those skilled in the art, such as convection drying, microwave drying, vacuum drying cabinets or combinations of these processes.

The gel can be dried under air or, if it is oxygen-sensitive, also under other gases such as nitrogen or noble gases, and it is possible for this purpose, if appropriate, to use a drying cabinet or other suitable apparatus in which the pressure, the temperature and the solvent content of the environment can be controlled.

The temperature and pressure conditions to be selected in the course of drying depend upon factors including the nature of the liquid present in the gel. According to the invention, drying is effected at a pressure which is below the critical pressure p_{crit} of the liquid present in the gel, preferably the solvent (C), and at a temperature which is below the critical temperature T_{crit}. Accordingly, drying is effected under subcritical conditions. In this context, critical means: at the critical pressure and the critical temperature, the density of the liquid phase is equal to the density of the gas phase (so-called critical density), and, at temperatures above T_{crit}, the fluid phase can no longer be liquefied even in the case of application of ultra high pressures.

When acetone is used as the solvent, drying is effected at temperatures of from 0° C. to 150° C., preferably from 10° C. to 100° C. and more preferably from 15° C. to 80° C., and at pressures from high vacuum, for example from 10⁻³ mbar, to 5 bar, preferably from 1 mbar to 3 bar and especially from 10 mbar to about 1 bar (absolute). For example, drying can be effected at atmospheric pressure and from 0° C. to 80° C., especially at room temperature. Particular preference is given to drying the gel in step (d) at a pressure of from 0.5 to 2 bar (absolute) and at a temperature of from 0 to 100° C.

Other liquids present in the gel, especially solvents (C) other than acetone, require adjustments to the drying conditions (pressure, temperature, time) which can be determined by the person skilled in the art by simple tests.

The drying can be accelerated or completed by applying a vacuum. In order to further improve the drying action, this vacuum drying can be undertaken at a higher temperature than the drying at customary pressure. For example, the majority of the solvent (C) can first be removed at room temperature and atmospheric pressure within from 30 min to 3 hours, and then the gel can be dried at from 40 to 80° C. under a reduced pressure of from 1 to 100 mbar, especially from 5 to 30 mbar, within from 10 min to 6 hours. It will be appreciated that longer drying times are also possible, for example from 1 to 5 days. However, preference is frequently given to drying times of below 12 hours.

Instead of such a stepwise drying, the pressure can also be lowered continuously, for example in a linear or exponential manner, during the drying, or the temperature can be increased in such a manner, i.e. according to a pressure or temperature program. By its nature, the lower the moisture content of the air, the more rapidly the gel dries. The same applies mutatis mutandis to liquid phases other than water and to gases other than air.

The preferred drying conditions depend not only on the solvent but also on the nature of the gel, especially the stability of the network in relation to the capillary forces acting in the course of drying.

In the course of drying in step (d), the liquid phase is generally removed completely or down to a residual content of from 0.01 to 1% by weight based on the resulting xerogel,

Properties of the Xerogels and Use

The xerogels obtainable by the process according to the invention have a volume-averaged mean pore diameter of at most 5 μm. The volume-averaged mean pore diameter of the xerogels obtainable by the process according to the invention is preferably from 200 nm to 5 μm.

The particularly preferred volume-weighted mean pore diameter of the xerogels obtainable by the process according to the invention is at most 5 μm, especially at most 3.5 μm, most preferably at most 2.5 μm.

Although a minimum mean pore diameter with simultaneously high porosity is in principle desired from the point of view of reduced thermal conductivity, the lower limit in the mean pore diameter arises through the worsening of mechanical properties of the xerogel, especially its stability and processability, by practical considerations. In general, the volume-weighted mean pore diameter is at least 200 nm, preferably at least 400 nm. In many cases, the volume-weighted mean pore diameter is at least 500 nm, especially at least 1 micrometer.

The xerogels obtainable by the process according to the invention preferably have a porosity of at least 70% by volume, especially from 70 to 99% by volume, more preferably at least 80% by volume, most preferably at least 85% by volume, especially from 85 to 95% by volume. The porosity in % by volume means that the stated proportion of the total volume of the xerogel consists of pores. Although a maximum porosity is usually desired from the point of view of minimal thermal conductivity, the upper limit in the porosity arises through the mechanical properties and the processability of the xerogel.

The density of the organic xerogels obtainable by the process according to the invention is typically from 20 to 600 g/l, preferably from 50 to 500 g/l and more preferably from 100 to 400 g/l.

The process according to the invention gives rise to a coherent porous material and not just a polymer powder or polymer particles. The three-dimensional shape of the resulting xerogel is determined by the shape of the gel, which is determined in turn by the shape of the gelation apparatus. For example, a cylindrical gelation vessel typically gives rise to an approximately cylindrical gel which is then dried to a xerogel in cylinder form.

The inventive xerogels and the xerogels obtainable by the process according to the invention have a low thermal conductivity, a high porosity and a low density. According to the invention, the xerogels have a low mean pore size. The combination of the aforementioned properties allows use as an insulating material in the field of thermal insulation, especially for applications in the vacuum sector where a minimum thickness of vacuum panels is preferred, for example in cooling units or in buildings. For instance, preference is given to use in vacuum insulation panels, especially as a core material for vacuum insulation panels. Preference is also given to the use of the inventive xerogels as an insulating material.

Furthermore, the low thermal conductivity of the inventive xerogels enables applications at pressures of from 1 to 100 mbar and especially from 10 mbar to 100 mbar. The property profile of the inventive xerogels opens up especially applications in which a long lifetime of the vacuum panels is desired and which have a low thermal conductivity even in the case of a pressure increase of about 2 mbar per year even after many years, for example at a pressure of 100 mbar. The inventive xerogels and the xerogels obtainable by the process according to the invention have favorable thermal properties on the one hand, and favorable material properties such as simple processability and high mechanical stability, for example low brittleness, on the other hand.

### EXAMPLES

The pore volume in ml per g of sample and the mean pore size of the materials were determined by means of mercury porosimetry to DIN 66133 (1993) at room temperature. In the context of this invention, the mean pore size can be equated to the mean pore diameter. The volume-weighted mean pore diameter is determined by calculation from the pore size distribution determined according to the abovementioned standard.

The porosity in the unit % by volume was determined by the formula P=(Vᵢ/(Vᵢ+Vₛ))M+Vs))*100% by volume, where P is the porosity, Vₗ is the Hg intrusion volume to DIN 66133 in ml/g and Vₛ is the specific volume in ml/g of the specimen.

The density p of the porous material in the unit g/ml was calculated by the formula ρ=1/(V₁+Vₛ). The specific volume used for porous materials based on melamine and formaldehyde was the value 1/Vₛ=1.68 g/ml, and the specific volume used for porous materials based on isocyanate was the value 1/Vₛ=1.38 g/ml. Both values were determined by He pycnometry.

The thermal conductivity λ was determined by means of the dynamic hot wire method.

In the hot wire method, a thin wire is embedded in the sample to be analyzed, which serves simultaneously as the heating element and temperature sensor. The wire material used was a platinum wire with a diameter of 100 micrometers and a length of 40 mm, which was embedded between two halves of the particular specimen. The test setup composed of sample and hot wire was prepared in an evacuable recipient in which, after the evacuation, the desired pressure was established by admitting gaseous nitrogen.

During the experiment, the wire was heated at constant power. The temperature was 25° C. The evolution with time of the resulting temperature rise at the site of the heating wire was recorded by measuring the resistance. The thermal conductivity was determined by fitting an analytical solution to the evolution of temperature with time, taking account of a thermal contact resistance between sample and wire, and axial heat losses, according to H.-P. Ebert et al., High Temp.-High. Press, 1993, 25, 391-401. The gas pressure was determined with two capacitative pressure sensors with different measurement ranges (0.1 to 1000 mbar and 0.001 to 10 mbar).

### Example 1

a) 1.9 g of oligomeric MDI (Lupranat® M200 R) with an NCO content of 30.9 g per 100 g to ASTM D-5155-96 A, a functionality in the region of three and a viscosity of 2100 mPa.s at 25° C. to DIN 53018 were dissolved in 10.6 g of acetone in a beaker at 20° C. with stirring. 1.26 g of 4,4′ -diaminodlphenylmethane were dissolved in 10.9 g of acetone in a second bëaker.

b) The two solutions from stop (a) were mixed. A clear low-viscosity mixture was obtained. The mixture was left to stand at room temperature for 24 hours for curing.

d) Subsequently, the gel was removed from the beaker and the liquid (acetone) was removed by drying at 20° C. for 7 days.

The resulting material had a pore volume of 5.1 ml/g and an average pore diameter of 2.9 μm. The porosity was 87% by volume with a corresponding density of 170 g/l. The thermal conductivity λ of the resulting material can be seen in table 1.

TABLE 1
Thermal conductivity λ (example 1)

| Pressure [mbar] | λ [mW/m * K] |
|---|---|
| 1 | 6.5 |
| 2.1 | 7.8 |
| 3.1 | 8.9 |
| 7 | 12.2 |
| 14 | 14 |
| 41 | 20.1 |
| 71 | 26.3 |
| 100 | 28.8 |
| 299 | 34 |
| 701 | 36.7 |
| 1004 | 37.6 |

### Example 2

a) 1.9 g of oligomeric MDI (Lupranat® M200 R) with an NCO content of 30.9 g per 100 g to ASTM D-5155-96 A, a functionality in the region of three and a viscosity of 2100 mPa.s at 25° C. to DIN 53018 were dissolved in 14 g of dioxane in a beaker at 20° C. with stirring. 1.24 g of 4,4′-diaminodiphenylmethane were dissolved in 14.4 g of dioxane in a second beaker.

b) The two solutions from step (a) were mixed. A clear low-viscosity mixture was obtained. The mixture was left to stand at room temperature for 24 hours for curing.

d) Subsequently, the gel was removed from the beaker and the liquid (dioxane) was removed by drying at 20° C. for 7 days.

The resulting material had a pore volume of 4.1 ml/g and an average pore diameter of 2.5 μm. The porosity was 85% by volume with a corresponding density of 207 g/l. The resulting material had a thermal conductivity λ of 5.7 mW/m*K at a pressure of 1.53 mbar.

### Comparative Example 3C

a) 4.19 g of oligomeric MDI (Lupranat® M20 S) having an NCO content of 31.8 g per 100 g to ASTM D-5155-96 A, a viscosity of 220 mPa.s at 25° C. and a functionality of about 2.7 were dissolved in 50 g of acetone in a beaker at 20° C. with stirring. 2.66 g of diethyltoluenediamine (Ethacure® 100, a mixture of 3,5-diethyltoluene-2,4-diamine and 3,5-diethyltoluene-2,6-diamine) were dissolved in 50 g of acetone in a second beaker.

b) The two solutions from step (a) were mixed. A clear low-viscosity mixture was obtained. The mixture was left to stand at room temperature for 24 hours for curing.

d) Subsequently, the gel was removed from the beaker and the liquid (acetone) was removed by drying at 20° C. for 7 days.

The gel body obtained in step (b) had a greasy consistency and exhibited a low mechanical stability. The product obtained in d) had a significantly shrunken form compared to examples 1 and 2.

### Example 4C

a) 1.56 g of oligomeric MDI (Lupranat® M200 R) with an NCO content of 30.9 g per 100 g to ASTM D-5155-96 A, a functionality in the region of three and a viscosity of 2100 mPa.s at 25° C. to DIN 53018 and 0.8 g of diethyltoluenediamine (Ethacure® 100, a mixture of 3,5-diethyltoluene-2,4-diamine and 3,5-diethyl-toluene-2,6-diamine) were dissolved in 34 g of acetone in a beaker at 20° C. with stirring.

b) The mixture was left to stand at room temperature for 24 hours for curing.

d) Subsequently, the gel was taken out of the beaker and the liquid (acetone) was removed by drying at 20° C. for 7 days.

The gel body obtained in step (b) had a greasy consistency and exhibited a low mechanical stability. The product obtained in d) had a significantly shrunken form compared to examples 1 and 2.

1. A xerogel comprising
from 30 to 90% by weight of units of monomer component (a1) of at least one polyfunctional isocyanate, and
from 10 to 70% by weight of units of monomer component (a2) of at least one polyfunctional aromatic amine, and at least one of which is selected from 4,4′-diaminodiphenylmethane, 2,4′-diaminodiphenylmethane, 2,2′-diaminodiphenylmethane or and oligomeric diaminodiphenylmethane;
where the units of monomer components (a1) and (a2) adds up to 100% by weight, and a volume-weighted mean pore diameter of the xerogel is from 0.4 to 3.5 μm, as determined by mercury instrusion measurement, and a porosity of 80 to 95% by volume.

2. The xerogel according to claim 1, comprising from 40 to 80% by weight of the units of monomer component (a1), and from 20 to 60% by weight of the units of monomer component (a2).

3. (canceled)

4. The xerogel according to claim 1, comprising from 50 to 70% by weight of the units of monomer component (a1), and from 30 to 50% by weight of the units of monomer component (a2).

5. The xerogel according to claim 1, wherein the monomer component (a2) includes oligomeric diaminodiphenylmethane, and has a functionality of at least 2.5.

6. The xerogel according to claim 1, wherein the at least one polyfunctional isocyanate is selected from diphenylmethane 4,4′-diisocyanate, diphenylmethane 2,4′-diisocyanate, diphenylmethane 2,2′-diisocyanate or and oligomeric diphenylmethane diisocyanate.

7. The xerogel according to claim 1, wherein the monomer component (a1) comprises oligomeric diphenylmethane diisocyanate and has a functionality of at least 2.5.

8. The xerogel according to claim 1, wherein the monomer component (a1) comprises an oligomeric diphenylmethane diisocyanate and the monomer component (a2) comprises oligomeric diaminodiphenylmethane, and the sum of functionality of the monomer component (a1) and of the functionality of the monomer component (a2) is at least 5.5.

9.-13. (canceled)

14. An insulating material comprising an xerogel according to claim 1.

15. A vacuum insulation panel comprising an xerogel according to claim 1.

16. The xerogel according to claim 6 with a density of 100 to 400 g/l.

17. The xerogel according to claim 8 with a density of 100 to 400 g/l.

18. A xerogel with a polymeric network consisting of;
40 to 80% by weight of monomer units of an aromatic diisocyanate selected from diphenylmethane 2,2′-diisocyanate, diphenylmethane 2,4′-diisocyanate, diphenylmethane 4,4′-diisocyanate, naphthylene 1,5-diisocyanate, dimethyldiphenyl 3,3′-diisocyanate, oligomeric diaminodiphenylmethane and any one mixture thereof, and
20 to 60% by weight of monomer units of an aromatic diamine is selected from 4,4′-diaminodiphenylmethane, 2,4′-diaminodiphenylmethane, 2,2′-diaminodiphenylmethane, oligomeric diaminodiphenylmethane, or any one mixture thereof;
wherein the monomer units of the aromatic diisocyanate and the aromatic diamine accounts for 100% by weight of all monomeric units in the xerogel, and the xerogel has a volume-weighted mean pore diameter of from 0.4 to 3.5 μm, as determined by mercury intrusion measurement, and a porosity of 80 to 95% by volume.

19. The xerogel according to claim 18, wherein the aromatic diisocyanate includes oligomeric diphenylmethane diisocyanate, and a mean functionality of the diisocyanate is from 2.3 to 3.5.

20. The xerogel according to claim 19 with a density of 100 to 400 g/l.

21. An insulating material comprising an xerogel according to claim 20.

22. A vacuum insulation panel comprising an xerogel according to claim 20.
